(19) United States
(12) Patent Application Publication
(10) Pub. No.: US 2026/0252096 A1
(43) Pub. Date: Aug. 27, 2026

(54) INFORMATION PROCESSING APPARATUS, CONTROLLING SYSTEM, INFORMATION PROCESSING METHOD, AND RECORDING MEDIUM

(71) Applicant: NEC Corporation, Tokyo (JP)

(72) Inventors: Florence Thi Ngoc Loan HO, Tokyo (JP); Ryota HIGA, Tokyo (JP)

(21) Appl. No.: 19/064,688

(22) Filed: Feb. 27, 2025

(51) Int. Cl. G05D 1/644; G05D 1/698; G05D 101/15; G05D 105/28; G05D 107/70; G06F 9/48

(52) U.S. Cl. CPC G05D 1/644; G05D 1/6987; G06F 9/4881; G05D 2101/15; G05D 2105/28; G05D 2107/70

(57) ABSTRACT

An information processing apparatus for solving one or more online optimization problems, including at least one processor and a memory which is configured to store instructions, the at least one processor executing: an obtaining process of obtaining a problem setting; a generating process of generating a metaheuristic solver with reference to the problem setting; a solving process of solving a problem including one or more tasks using the metaheuristic solver so as to provide a solution to the problem including the one or more tasks; and an updating process of updating the metaheuristic solver with reference to a new task so as to provide a solution to the problem including the new task.

### TECHNICAL FIELD

The present invention relates to an information processing apparatus, a controlling system, an information processing method, and a recording medium.

### BACKGROUND ART

There are various known techniques and applications of optimization method. For example, Patent Literature 1 discloses a method of dynamic fleet routing by optimizing the routes of vehicles that perform delivery services.

### Citation List

### Patent Literature

### Patent Literature 1

International Patent Application Publication No. WO2015/154831 A1

### SUMMARY OF INVENTION

### Technical Problem

The known techniques of optimization usually use a solver or strategy to derive a solution to a given task. For example, the technique disclosed in Patent Literature 1 uses fixed time slots (batches) strategy based on a fixed formula of slack time.

In the known techniques, such solver or strategy is usually designed and updated by a human expert, which may cause a problem of lack of flexibility and difficulty of increasing throughputs.

The present disclosure has been made in view of the above problem, and an example object thereof is to provide a technique of online optimization with improved flexibility and throughput.

### Solution to Problem

An information processing apparatus for solving one or more online optimization problems, in accordance with an example aspect of the present disclosure, comprising at least one processor and a memory which is configured to store instructions, the at least one processor executing: an obtaining process of obtaining a problem setting; a generating process of generating a metaheuristic solver with reference to the problem setting; a solving process of solving a problem including one or more tasks using the metaheuristic solver so as to provide a solution to the problem including the one or more tasks; and an updating process of updating the metaheuristic solver with reference to a new task so as to provide a solution to the problem including the new task.

A controlling system for solving one or more online vehicle routing problems and for controlling a plurality of vehicles, in accordance with an example aspect of the present disclosure, the controlling system comprising at least one processor and a memory which is configured to store instructions, the at least one processor executing: an obtaining process of obtaining a problem setting; a generating process of generating a metaheuristic solver with reference to the problem setting; a solving process of solving a problem including one or more tasks using the metaheuristic solver so as to provide a solution to the problem including the one or more tasks; an updating process of updating the metaheuristic solver with reference to a new task so as to provide a solution to the problem including the new task; and a controlling process of controlling the vehicles by providing, to the vehicles, the solution provided by the solving process or the updating process.

An information processing method for solving one or more online optimization problems, executed by least one processor, in accordance with an example aspect of the present disclosure, comprising: obtaining a problem setting; generating a metaheuristic solver with reference to the problem setting; solving a problem including one or more tasks using the metaheuristic solver so as to provide a solution to the problem including the one or more tasks; and updating the metaheuristic solver with reference to a new task so as to provide a solution to the problem including the new task.

A non-transitory recording medium, in accordance with an example aspect of the present disclosure, in which a program for causing a computer to function as the information processing apparatus recited above is stored, the program causing the computer to execute the obtaining process, the generating process, the solving process, and the updating process.

### Advantageous Effects of Invention

An example aspect of the present disclosure brings about an example effect that it is possible to provide a technique of online optimization with improved flexibility and throughput.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a block diagram illustrating a configuration of a controlling system in accordance with the present disclosure.

FIG. 4 is a block diagram illustrating a configuration of a controlling system in accordance with the present disclosure.

FIG. 5 is a flowchart illustrating a flow of an information processing method in accordance with the present disclosure.

FIG. 6 is a diagram illustrating a process carried out in the information processing apparatus in accordance with the present disclosure.

FIG. 7 is a diagram illustrating a process carried out in the information processing apparatus in accordance with the present disclosure.

FIG. 8 is a diagram illustrating a process carried out in the information processing apparatus in accordance with the present disclosure.

FIG. 9 is a diagram illustrating an application example of the controlling system in accordance with the present disclosure.

FIG. 10 is a block diagram illustrating a hardware configuration of an information processing apparatus in accordance with the present disclosure.

### EXAMPLE EMBODIMENTS

The following will exemplify embodiments of the present invention. Note, however, that the present invention is not limited to the example embodiments described below, but may be altered in various ways by a skilled person within the scope of the claims. For example, the present invention can also encompass, in its scope, any example embodiment derived by appropriately combining technical means employed in the example embodiments described below. Further, the present invention can also encompass, in its scope, any example embodiment derived by appropriately omitting a part of a technical means employed in each of the example embodiments described below. Further, the effects mentioned in the example embodiments described below are examples of the effects expected in the example embodiments described below, and are not intended to define an extension of the present invention. That is, the present invention can also encompass, in its scope, any example embodiment that does not bring about any of the effects mentioned in the example embodiments described below.

### First Example Embodiment

The following description will discuss a first example embodiment, which is an example of an embodiment of the present invention, in detail, with reference to the drawings. The present example embodiment is a basic form of the example embodiments described later. Note that the scope of application of technical means which are employed in the present example embodiment is not limited to the present example embodiment. That is, the technical means which are employed in the present example embodiment can be employed also in the other example embodiments included in the present disclosure, within a range in which no particular technical problem occurs. Moreover, technical means which are indicated in the drawings referred to for describing the present example embodiment can be employed also in the other example embodiments included in the present disclosure, within a range in which no particular technical problem occurs.

### Configuration of Information Processing Apparatus 1

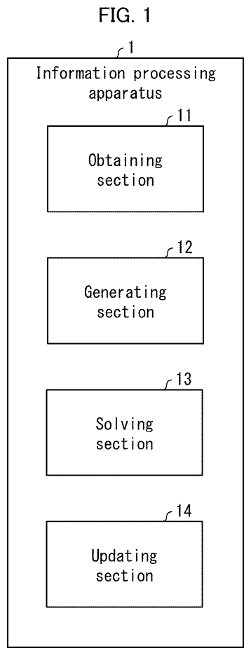

A configuration of an information processing apparatus 1 in accordance with the present example embodiment is described with reference to FIG. 1. FIG. 1 is a block diagram illustrating the configuration of the information processing apparatus 1. The information processing apparatus 1 is configured so as to solve one or more types of online optimization problem. An online optimization problem treated or solved by the information processing apparatus 1 may be referred to as a target online optimization problem (or target problem in short). Target online optimization problems may, for example, include joint task allocation problem and path planning problem, but these examples do not limit the present example embodiment. The information processing apparatus 1 includes, as illustrated in FIG. 1, an obtaining section 11, a generating section 12, a solving section 13, and an updating section 14.

### Obtaining Section 11

The obtaining section 11 obtains input data which includes one or more problem settings. Here, the problem setting may include one or more pieces of information defining a target online optimization problem. For example, the problem setting may include one or more constraint conditions, and one or more cost functions which define at least a part of the target online optimization problem. More specifically, if the information processing apparatus 1 deals with the path planning problem, or in other words, Dynamic/Online Vehicle Routing Problem (VRP), the problem settings may further include a map with static obstacles, start depot and goal depots, and the number of vehicles, etc..

### Generating Section 12

The generating section 12 automatically generates a metaheuristic solver with reference to the problem setting obtained by the obtaining section 11. Here, the metaheuristic solver is a solver to solve the target online optimization problem based on a metaheuristic algorithm. Note that a specific configuration of the metaheuristic solver does not limit the present example embodiment. The generating section 12 may utilize a machine learned generative model (for example, a large language model LLM) to generate the metaheuristic solver. But, this example does not limit the present example embodiment. A metaheuristic solver may be referred to simply as a solver.

### Solving Section 13

The solving section 13 solves the target problem including one or more tasks using the metaheuristic solver generated by the generation section 12 so as to provide a solution to the target problem including the one or more tasks. For example, the solving section 13 carries out: a first task-obtaining process of obtaining one or more initial tasks; and a first task-solving process of solving the target problem including the one or more initial tasks using the metaheuristic solver so as to provide a solution to the target problem including the one or more initial tasks. The solving process carried out by the solving section 13 may also be expressed as calculating a solution plan for the initial tasks using the generated metaheuristic solver SV. The solution derived by the solving section 13 may also be referred to as a solution plan.

### Updating Section 14

The updating section 14 automatically updates the metaheuristic solver with reference to a new task so as to provide a solution to the target problem including the new task. For example, the updating section 14 carries out: a second task-obtaining process of obtaining a new task; a solver-updating process of updating the metaheuristic solver with reference to the new task; and a second task-solving process of solving the target problem including the new task using the updated metaheuristic solver so as to provide a solution to the target problem including the new task. The process carried out by the updating section 14 may also be expressed as re-optimizing the solution plan SL which includes the new tasks TS, using the updated metaheuristic solver SV. The updating section 14 may utilize a machine learned generative model (for example, a large language model LLM) to update the metaheuristic solver. But, this example does not limit the present example embodiment.

### Effect of Information Processing Apparatus 1

As has been described, the information processing apparatus 1 employs a configuration such that:
the input data including the problem setting of the target online optimization problem is obtained;
the metaheuristic solver is automatically generated with reference to the problem setting;
the target problem including one or more tasks is solved by using the metaheuristic solver, and a solution to the target problem including the one or more tasks is provided; and
the metaheuristic solver is automatically updated with reference to a new task, and a solution to the target problem including the new task is provided.
   According to the above configuration, the metaheuristic solver is automatically generated by the generating section 12 and updated by the updating section 14. Therefore, according to the above configuration, it is possible to provide a technique of online optimization with improved flexibility and throughput.

### Flow of Information Processing Method S1

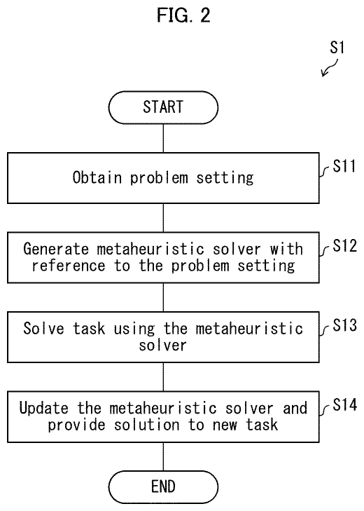

Next, a flow of an information processing method S1 in accordance with the present example embodiment is described with reference to FIG. 2. FIG. 2 is a flowchart illustrating the flow of the information processing method S1. As illustrated in FIG. 2, the information processing method S1 includes: a step (process) S11 of obtaining the input data which includes a problem setting; a step (process) S12 of generating a metaheuristic solver; a step (process) S13 of solving a problem instance that includes one or more tasks using the metaheuristic solver; and a step (process) S14 of updating the metaheuristic solver and providing a solution to a new problem with one or several new tasks.

### Step S11

In the step S11, the obtaining section 11 obtains the input data which includes one or more problem settings. A specific process carried out by the obtaining section 11 has been described above, and therefore description thereof is omitted here.

### Step S12

Next, in the step S12, the generating section 12 automatically generates a metaheuristic solver with reference to the problem setting obtained by the obtaining section 11. A specific process carried out by the generating section 12 has been described above, and therefore description thereof is omitted here.

### Step S13

Next, in the step S13, the solving section 13 solves the target problem including one or more tasks using the metaheuristic solver generated by the generation section 12 so as to provide a solution to the target problem including the one or more tasks. A specific process carried out by the solving section 13 has been described above, and therefore description thereof is omitted here.

### Step S14

Next, in the step S14, the updating section 14 automatically updates the metaheuristic solver with reference to a new task so as to provide a solution to the target problem including the new task. A specific process carried out by the updating section 14 has been described above, and therefore description thereof is omitted here.

### Effect of Information Processing Method S1

As has been described, the information processing method S1 employs a configuration such that:
the input data including the problem setting of the target online optimization problem is obtained;
the metaheuristic solver is automatically generated with reference to the problem setting;
the target problem including one or more tasks is solved by using the metaheuristic solver, and a solution to the target problem including the one or more tasks is provided; and
the metaheuristic solver is automatically updated with reference to a new task, and a solution to the target problem including the new task is provided.
   The information processing method S1 configured in this manner is also capable of bringing about the above-described effect.

### Configuration of Controlling System 100

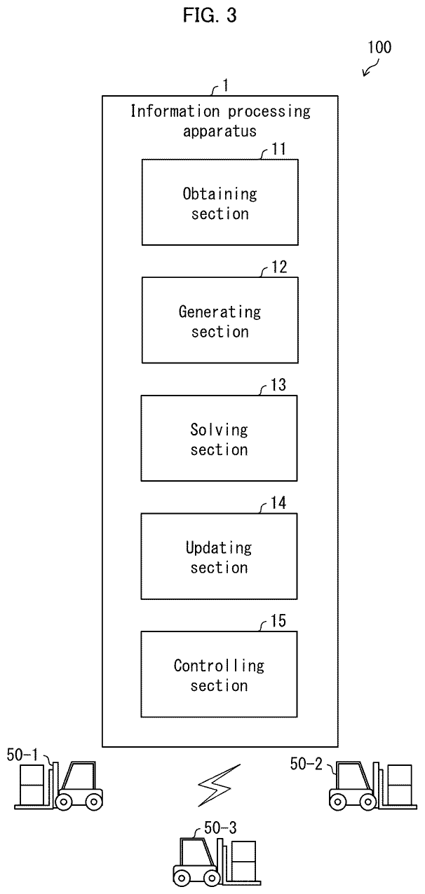

A configuration of a controlling system 100 in accordance with the present example embodiment is described with reference to FIG. 3. FIG. 3 is a block diagram illustrating the configuration of controlling system 100. The controlling system 100 is configured so as to: solve one or more types of online optimization problem; and control one or more vehicles. Here the online optimization problem may be a path planning problem, or in other words, Dynamic/Online Vehicle Routing Problem (VRP), but these examples do not limit the present example embodiment. The controlling system 100 includes, as illustrated in FIG. 3, an information processing apparatus 1, and a plurality of vehicles 50-1 to 50-3. The information processing apparatus 1 includes, as illustrated in FIG. 3, an obtaining section 11, a generating section 12, a solving section 13, an updating section 14, and a controlling section 15. The obtaining section 11, the generating section 12, the solving section 13, and the updating section 14 have been described above, and therefore descriptions thereof are omitted here.

### Controlling Section 15

The controlling section 15 controls the vehicles 50-1 to 50-3 by providing, to the vehicles 50-1 to 50-3, the solution provided by the solving section 13 or the updating section 14. For example, the controlling section 15 may provide, to the vehicles 50-1 to 50-3, the tasks sequence and associated path for each vehicle. Here the tasks sequence and associated path for each vehicle are included in the solution provided by the solving section 13 or the updating section 14.

### Effect of Controlling System 100

As has been described, the controlling system 100 employs a configuration such that:
the input data including the problem setting of the target online optimization problem is obtained;
the metaheuristic solver is automatically generated with reference to the problem setting;
the target problem including one or more tasks is solved by using the metaheuristic solver, and a solution to the target problem including the one or more tasks is provided;
the metaheuristic solver is automatically updated with reference to a new task, and a solution to the target problem including the new task is provided; and
the one or more vehicles are controlled in accordance with the solution derived by the solving section 13 or the updating section 14.
   According to the above configuration, the metaheuristic solver is automatically generated by the generating section 12 and updated by the updating section 14. Then the one or more vehicles are controlled in accordance with the solution derived by the solving section 13 or the updating section 14. Therefore, according to the above configuration, it is possible to control one or more vehicles by using a technique of online optimization with improved flexibility and throughput.

### Second Example Embodiment

The following description will discuss a second example embodiment, which is an example of an embodiment of the present invention, in detail, with reference to the drawings. The same reference signs are given to constituent elements having the same functions as those of the constituent elements described in the foregoing example embodiment, and descriptions of the constituent elements are omitted as appropriate. Note that the scope of application of techniques which are employed in the present example embodiment is not limited to the present example embodiment. That is, the techniques which are employed in the present example embodiment can be employed also in the other example embodiments included in the present disclosure, within a range in which no particular technical problem occurs. Moreover, techniques indicated in the drawings referred to for describing the present example embodiment can be employed also in the other example embodiments included in the present disclosure, within a range in which no particular technical problem occurs.

### Configuration of Controlling System 100A

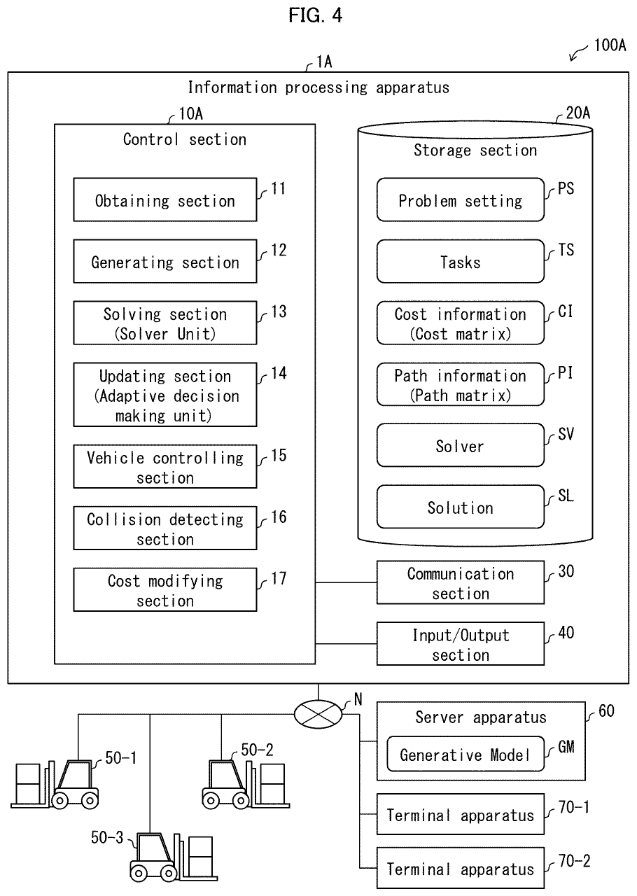

A configuration of a controlling system 100A in accordance with the present example embodiment is described with reference to FIG. 4. FIG. 4 is a block diagram illustrating the configuration of the controlling system 100A. The controlling system 100A is configured so as to: solve one or more types of online optimization problem (target online optimization problem, or target problem in short); and control one or more vehicles. Here the online optimization problem may be a path planning problem, or in other words, Dynamic/Online Vehicle Routing Problem (VRP), but these examples do not limit the present example embodiment. The controlling system 100A may be configured to solve a task allocation problem, or other optimization problem. The controlling system 100A includes, as illustrated in FIG. 4, an information processing apparatus 1A, a plurality of vehicles 50-1 to 50-3, a server apparatus 60, and a plurality of terminal apparatuses 70-1 to 70-2. The vehicles 50-1 to 50-3, the server apparatus 60 and the terminal apparatuses 70-1 to 70-2 are connected to the information processing apparatus 1A via a network N. Note, here, that, although a detailed configuration of the network N does not limit the present example embodiment, the network N can be, for example, a wireless local area network (LAN), a wired LAN, a wide area network (WAN), a public network, a mobile data communication network, or a combination of any of these networks. Note that it is not essential for the controlling system 1A to include the server apparatus 60, and the information processing apparatus 1A may have the functions of the server apparatus 60. Such a configuration is also encompassed in the present example embodiment.

### Vehicles 50-1 to 50-3

The vehicles 50-1 to 50-3 are controlled by the information processing apparatus 1A. More specifically, the vehicles 50-1 to 50-3 receive one or more solutions (one or more solution plans) of the target online optimization problem solved by the information processing apparatus 1A. A specific configuration of the vehicles 50-1 to 50-3 does not limit the present example embodiment, but, as an example, the vehicles 50-1 to 50-3 may be realized by automated guided vehicle (AGV) which are configured to carry one or more items. Note that the number of vehicles 50 does not limit the present example embodiment.

### Server Apparatus 60

The server apparatus 60 includes one or more generative models GM. Each of the generative models GM may be a machine learned model. More specifically, each of the generative models GM may be a trained large language model (LLM). Various pieces of data provided from the information processing device 1A are inputted into the generative model GM, and output data outputted by the generative model GM is provided to the information processing apparatus 1A. For example, the server apparatus 60 receives one or more prompts generated by the information apparatus 1A, and input the received prompt to the generative model GM.

In an example, the prompt may include a problem setting of the target online optimization problem, and an instruction to generate a metaheuristic solver with reference to the problem setting. The generative model GM generates and outputs one or more programming codes of the metaheuristic solver with reference to the prompt. The generated programming code of the metaheuristic solver is provided to the information processing apparatus 1A.

In another example, the prompt may include one or more tasks to be carried out in the target online optimization problem, and an instruction to update the metaheuristic solver with reference to the one or more tasks. The generative model GM updates and outputs one or more programming codes of the metaheuristic solver with reference to the prompt. The updated programming code of the metaheuristic solver is provided to the information processing apparatus 1A.

In yet another example, the prompt may include one or more tasks to be carried out in the target online optimization problem, and an instruction to decide whether to solve the tasks or to wait for another task. The generative model GM makes decision whether to solve the tasks or to wait for another task with reference to the prompt. The result of the decision making by the generative model GM is provided to the information processing apparatus 1A. Specific examples of the prompts will be described later.

### Terminal Apparatus 70

The terminal apparatuses 70-1 to 70-2 are operated by customers or users. Each customer may input his/her own request to the terminal apparatus 70, then the request is transmitted to the information processing apparatus 1A. Note that the number of apparatuses 70 does not limit the present example embodiment.

### Configuration of Information Processing Apparatus 1A

A configuration of an information processing apparatus 1A in accordance with the present example embodiment is described with reference to FIG. 4. As illustrated in FIG. 4, the information processing apparatus 1A includes a control section 10A, a storage section 20A, a communication section 30, and an input/output section 40.

### Communication Section 30

The communication section 30 carries out communication with an apparatus external to the information processing apparatus 1A via a network N. As an example, the communication section 30 transmits, to the external apparatus, data supplied from the control section 10A, and supplies, to the control section 10A, data received from the external apparatus. In an example the communication section 30 transmits, to the server apparatus 60, the prompts generated by the control section 10A, and receives an output of the generative model GM. In another example the communication section 30 transmits, to the vehicles 50-1 to 50-3, the solution of the target online optimization problem derived by the control section 10A.

### Input/Output Section 40

The input/output section 40 is configured to include at least any one of input/output apparatuses such as a keyboard, a mouse, a display, a printer, and touch panel. Alternatively, the input/output section 40 may be configured such that at least any one of the input/output apparatuses such as a keyboard, a mouse, a display, a printer, and touch panel is connected to the input/output section 40. In this configuration, the input/output section 40 accepts, from an input apparatus connected thereto, input of various pieces of information with respect to the information processing apparatus 1A. Further, the input/output section 40 outputs various pieces of information to an output apparatus connected thereto under control by the control section 10A. Examples of the input/output section 40 include interfaces such as a universal serial bus (USB).

### Storage Section 20A

In the storage section 20A, various pieces of data that are referred to by the control section 10A and various pieces of data that have been generated by the control section 10A are stored. As an example, in the storage section 20A,
input data IND which includes one or more problem setting PS of the target online optimization problem,
one or more tasks TS,
cost information (cost matrix) CI,
path information (path matrix) PI,
one or more solvers (meta heuristic solvers) SV generated by a generating section 12 (described later),
one or more solutions (solution plans) SL derived or solved by the solving section 13 (described later), and the like are stored. Note, here, that the input data IND is data obtained by an obtaining section 11 (described later). A specific example of the input data IND will be described later. The one or more tasks TS are tasks to be carried out in the target online optimization problem. A specific example of the task TS will be described later. The cost information (cost matrix) CI includes or defines a cost of the solution SL. The cost information CI may also include information of a cost function defined in the target online optimization problem. The path information (path matrix) PI includes one or more paths indicated in the solution SL. Specific examples of the cost information CI and the path information PI will be described later.

### Control Section 10A

The control section 10A includes, as illustrated in FIG. 4, the obtaining section 11, the generating section 12, the solving section 13, the updating section 14, the vehicle controlling section 15, collision detecting section 16, and the cost modifying section 17. The solving section 13 may also referred to as a solver unit 13, and the updating section 14 may also referred to as an adaptive decision making unit 14.

### Obtaining Section 11

The obtaining section 11 obtains input data IND which includes one or more problem settings PS. Here, the problem setting PS may include one or more pieces of information defining the target online optimization problem. For example, the problem setting PS may include one or more constraint conditions, and one or more cost functions which define at least a part of the target online optimization problem. More specifically, in a case that the information processing apparatus 1A deals with the path planning problem, or in other words, Dynamic/Online Vehicle Routing Problem (VRP), the problem settings PS may further include a map with static obstacles, start depot and goal depots, and the number of vehicles, etc.

### Generating Section 12

The generating section 12 generates a metaheuristic solver SV with reference to the problem setting PS obtained by the obtaining section 11. Here, as mentioned in the first example embodiment, the metaheuristic solver SV is a solver to solve the target online optimization problem based on a metaheuristic algorithm. Note that a specific configuration of the metaheuristic solver does not limit the present example embodiment. The generating section 12 may utilize a pre-trained model or the generative model GM to generate the metaheuristic solver SV. More specifically, the generating section 12 may create a prompt to be inputted to the generative model GM and receives the output of the generative model GM. In an example, the generating section 12 may create a prompt which includes a problem setting PS of the target online optimization problem, and an instruction to generate a metaheuristic solver SV with reference to the problem setting PS. Here, the prompt may also include one or more initial tasks TS to be carried out in the target online optimization problem. The generative model GM generates and outputs one or more programming codes of the metaheuristic solver SV with reference to the prompt. Then, the generating section 12 may receive the programming codes of the metaheuristic solver SV. A more specific example of the prompt will be described later.

### Solving Section 13

The solving section 13 solves the target problem including a task TS using the metaheuristic solver SV generated by the generation section 12 so as to provide a solution SL to the target problem including the task TS. For example, the solving section 13 carries out: a first task-obtaining process of obtaining one or more initial tasks TS; and a first task-solving process of solving the target problem including the one or more initial tasks TS using the metaheuristic solver SV so as to provide a solution (solution plan) SL to the target problem including the one or more initial tasks TS. Note, here, in the first task solving process, in order to solve the initial task TS, the solving section 13 may execute the programming code of the metaheuristic solver SV generated by the generative model GM. The solving process carried out by the solving section 13 may also be expressed as calculating a solution plan SL for the initial tasks TS using the generated metaheuristic solver SV.

### Updating Section 14

The updating section 14 updates the metaheuristic solver SV with reference to a new task so as to provide a solution SL to the target problem including the new task TS. For example, the updating section 14 carries out: a second task-obtaining process of obtaining a new task TS; a solver-updating process of updating the metaheuristic solver SV with reference to the new task TS; and a second task-solving process of solving the target problem including the new task TS using the updated metaheuristic solver SV and the current information on the statuses of the vehicles so as to provide a solution SL to the target problem including the new task TS. Here, the current information on the statuses of the vehicles may include position data (position tracking) of the vehicles 50-1 to 50-3.

The process carried out by the updating section 14 may also include a decision making process of making a decision whether to solve the new task TS or to wait for another new task. The process carried out by the updating section 14 may also be expressed as determining how to process or solve the new tasks TS and adapt or update the metaheuristic solver SV as necessary. The updating section 14 may utilize a pre-trained decision making model or the generative model GM to carry out the decision making process. In an example, the updating section 14 may create a prompt including the new task TS to be carried out in the target online optimization problem, and an instruction to decide whether to solve the online optimization problem including the new task TS or to wait for another new task. The generative model GM makes decision whether to solve the online optimization problem including the new task TS or to wait for another task with reference to the prompt. Then, the updating section 14 may receive the result of the decision making by the generative model GM.

The process carried out by the updating section 14 may also be expressed as updating the metaheuristic solver SV, and re-optimizing the solution plan SL which includes the new tasks TS, using the updated metaheuristic solver SV. The updating section 14 may utilize a pre-trained model or the generative model GM to updates the metaheuristic solver SV. In an example, the updating section 14 may create a prompt including one or more new tasks TS to be carried out in the target online optimization problem, and an instruction to update the metaheuristic solver with reference to the one or more tasks. The prompt may also include a new constraint and/or a new cost function which define the target online optimization problem including the new tasks TS. The generative model GM updates and outputs one or more programming codes of the metaheuristic solver SV with reference to the prompt. Then, the updating section 14 may receive the updated programming code of the metaheuristic solver SV, and re-optimize the solution plan SL which includes the new tasks TS, using the updated metaheuristic solver SV. Note that since the solving section 13 and the updating section 14 derives the solution plan SL which contains a path planning for the vehicles, the solving section 13 and the updating section 14 may also be referred to as a path planning unit.

### Vehicle Controlling Section 15

The vehicle controlling section 15 controls the vehicles 50-1 to 50-3 by providing, to the vehicles 50-1 to 50-3, the solution plan SL provided by the solving section 13 or the updating section 14. For example, the vehicle controlling section 15 may provide, to the vehicles 50-1 to 50-3, the tasks sequence and associated path for each vehicle. Here the tasks sequence and associated path for each vehicle are included in the solution plan SL provided by the solving section 13 or the updating section 14.

### Collision Detecting Section 16 and Cost Modifying Section 17

The collision detecting section 16 predicts or detects one or more collisions of vehicles 50 which may happen in candidates of the paths of the vehicles 50 derived in the solving process of the solving section 13 or re-optimizing process of the updating section 14. If the collision detecting section 16 predicts or detects a collision in one or more paths, the cost modifying section 17 modifies the costs of the one or more paths. More specifically, the cost modifying section 17 increases the costs associated with the one or more paths and referred to by the solving section 13 or updating section 14. Due to the above processes, the paths which may cause a collision of the vehicles 50 may not be selected, by the solving section 13 or the updating section 14, in the solution plan SL. In other words, due to the above processes, the solving section 13 or the updating section 14 can provide collision-free paths for the vehicles 50-1 to 50-3.

### Example Flow of Processes Carried Out by the Information Processing Apparatus 1A

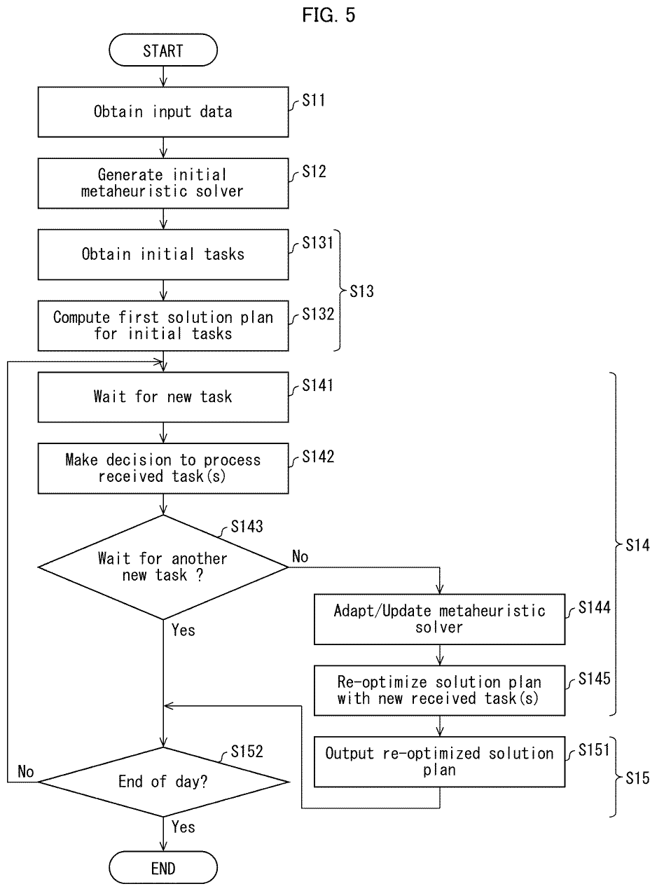

Next, an example flow of processes carried out by the information processing apparatus 1A in accordance with the present example embodiment is described with reference to FIG. 5. FIG. 5 is a flowchart illustrating the flow of processes carried out by the information processing apparatus 1A.

### Step S11

In the step S11, the obtaining section 11 obtains the input data IND which includes one or more problem settings PS. Some aspects of specific process carried out by the obtaining section 11 has been described above, and therefore duplicated description thereof is omitted here. In an example, the problem settings PS includes pieces of information defining the Dynamic/Online Vehicle Routing Problem (VRP). For example, the problem settings PS may include the following items:
a map of the target area with static obstacles
position information of start depot and goal depots
the number of vehicles 50
maximum payload capacity of each vehicle 50
constraints in the target online optimization problem
objective cost function in the target online optimization problem, which is to be minimized in the solving process or in the re-optimizing process.
   In an example, the constraints may include a constraint condition regarding time, path, location and/or payload. In an example, the cost function may be a function representing total travel distance for all vehicles 50. The problem settings PS may also include a set of initial requests (initial tasks TS).

More specifically, the Dynamic/Online Vehicle Routing Problem (VRP) may be defined as follows. In other words, at least a part of the problem setting PS may be expressed as follows.
Task requests by customers arrive at different times during the day, thus online optimization is necessary
During the day, at each time step t, a set At of new requests may arrive (each request j is the task TS with a location (x,y), demand Dj and service time STj). The current load of vehicle k at time may be expressed as Ck(t),
The Objective is to minimize the given cost (for example, total travel distance for all vehicles),
Compute optimal task allocation plan with collision-free paths for all vehicles,
Optimize throughput to service as many customers requests as possible.

In an example, the constraints in the Dynamic/Online Vehicle Routing Problem (VRP) or the corresponding problem setting PS may be expressed as follows.
Each task must be visited exactly once by a vehicle,
The total demand of tasks assigned to each vehicle should not exceed its capacity,
All planned paths for all vehicles must be collision-free,
Dynamic request processing: New requests At at time t need to be integrated into the plans of vehicles.

Note that the input data IND including the problem setting PS may be inputted to the information processing apparatus 1A through a GUI (graphical user interface) provided by the input/output section 40. The input data IND may include natural language texts. Note that the input data IND may also include position data (position tracking) of the vehicles 50-1 to 50-3.

### Step S12

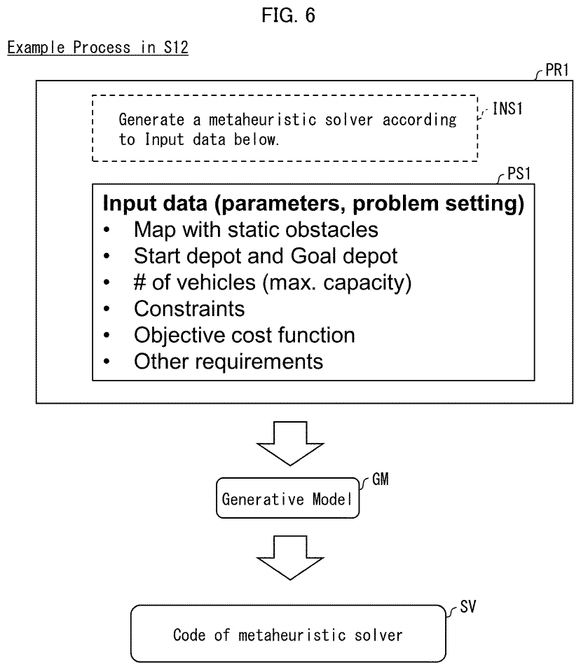

Next, in the step S12, the generating section 12 automatically generates a metaheuristic solver with reference to the problem setting obtained by the obtaining section 11. Some aspects of specific process carried out by the generating section 12 has been described above, and therefore duplicated description thereof is omitted here. FIG. 6 shows an example process carried out in the step S12. As illustrated in FIG. 6, the generating section 12 generates a prompt PR1 which includes an instruction sentence INS1, and the problem setting (input data) PS1. Here, the instruction sentence INS1 is an instruction to generate a metaheuristic solver SV with reference to the problem setting PS. Here, the prompt PS1 may also include one or more initial tasks TS to be carried out in the target online optimization problem. The generating section 12 provides the prompt PR1 to the generative model GM and obtains programming codes of the metaheuristic solver SV generated by the generative model GM. In an example, the metaheuristic solver SV generated by the generative model GM may include a metaheuristic algorithm that uses a 2-Opt heuristic strategy or a variant of the 2-Opt heuristic strategy. In another example, the metaheuristic solver SV may include a metaheuristic algorithm according to an ILS (Iterated Local Search) method which has been shown to efficiently solve VRP or Time-Dependent VRP (TDVRP). But these examples do not limit the present example embodiment.

### Step S131, S132

Next, in the step S131, the solving section 13 obtains one or more initial tasks TS. Here, for example, each of the initial tasks TS may include pieces of information of one or more task locations, items to be picked up or delivered to each of the task locations, and time slots of the pickup or the delivery. Then, in the step S132, the solving section 13 solves the target problem including the one or more initial tasks TS using the metaheuristic solver SV as to provide a solution plan SL to the target problem including the one or more initial tasks TS. In other words, the solving section 13 computes first solution plan SL for initial tasks using the metaheuristic solver SV. Note that, as explained above, the solving section 13 in cooperation with the collision detecting section 16 and the cost modifying section 17 may provide collision-free paths as the solution plan SL.

### Step S141, S142

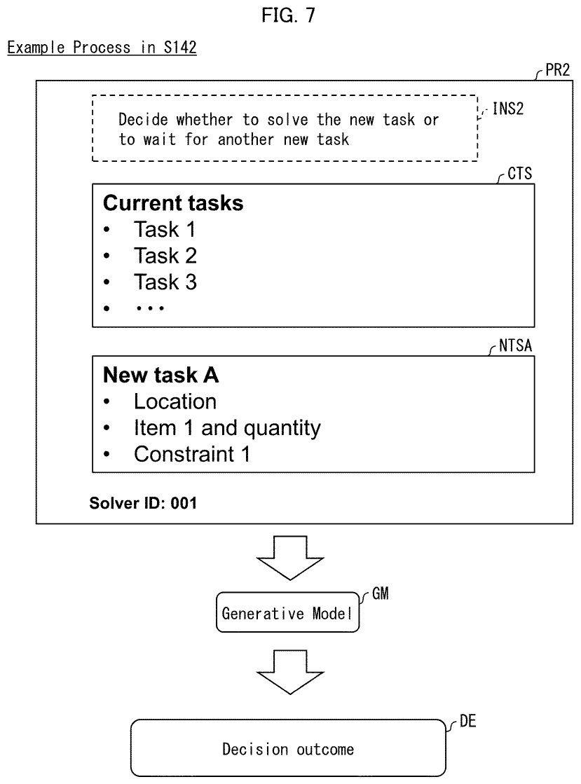

Next, in the step S141, the updating section 14 waits for a new task. If the updating section 14 receives one or more new tasks TS, the process proceeds to the step S142. Then, in the step S142, the updating section 14 makes decision whether to process or how to process the tasks TS received in the step S141. FIG. 7 shows an example process carried out in the step S142. As illustrated in FIG. 7, the updating section 14 generates a prompt PR2 which includes an instruction sentence INS2, current tasks CTS, and the new task NTSA. The prompt PR2 may also include an identification number of the metaheuristic solver SV or the code of the metaheuristic solver SV itself. The prompt PR2 may also include the current position data (position tracking) of the vehicles 50-1 to 50-3. Here, the instruction sentence INS2 is an instruction to make decision whether to solve the new task TS or to wait for another new task. The instruction sentence INS2 may also include an instruction to make decision how to solve the new task TS. The updating section 14 provides the prompt PR2 to the generative model GM and obtains the result of the decision making by the generative model GM.

Note that the process carried out in the step S142 may be expressed as deciding, by utilizing the generative model GM, whether or how to process received requests (received tasks) in accordance with one or more policies (or strategies). Here, the one or more policies are explicitly or implicitly taken into account by the generative model GM. Each policy may be related to some conditions or rules regarding time slots, batch size, etc.. These conditions or rules may be included in the prompt PR2. According to the step S142, there is no need to define, by human, one initial predetermined policy to address dynamic requests (tasks). The updating section 14 automatically determine which strategy (policy) is adapted anytime in step S142, and update the metaheuristic solver as explained in step S144 below.

### Step S143

In a case that the result of the decision making in the step S142 indicates to wait for other new tasks (Yes in step S143), the process proceeds to the step S147. Otherwise (No in step S143), the process proceeds to the step S144.

### Step S144

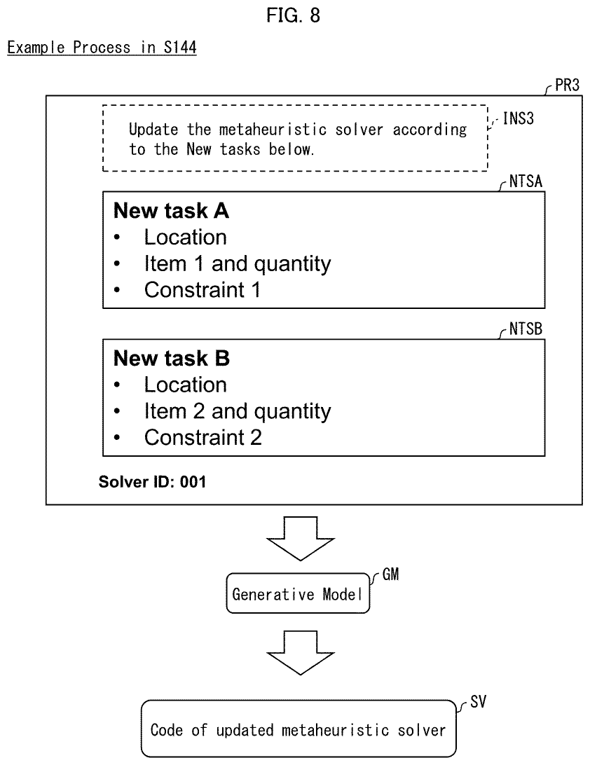

In the step S144, the updating section 14 adapts or updates the metaheuristic solver SV with reference to the new tasks obtained in the step S141. FIG. 8 shows an example process carried out in the step S144. As illustrated in FIG. 8, the updating section 14 generates a prompt PR3 which includes an instruction sentence INS3, the new task A (NTSA), and the new task B (NTSB). The prompt PR3 may also include an identification number of the metaheuristic solver SV or the code of the metaheuristic solver SV itself. Here, the instruction sentence INS3 is an instruction to adapt or update the metaheuristic solver SV with reference to the new tasks NTSA and NTSB obtained in the step S141. The updating section 14 provides the prompt PR3 to the generative model GM and obtains the codes of the updated metaheuristic solver SV generated by the generative model GM.

### Step S145

In the step S145, the updating section 14 solves the target problem including the new tasks NTSA and NTSB using the updated metaheuristic solver SV. In other words, the updating section 14 re-optimizes the solution plan SL with new received task(s) NTSA and NTSB. The solution plan SL may contain one or more sequences of the task and associated path for each vehicle. Note that, as explained above, the updating section 14 in cooperation with the collision detecting section 16 and the cost modifying section 17 may provide collision-free paths as the re-optimized solution plan SL.

Note that the processes carried out in the step S144, S145 and S142 may also be expressed follows. The updating section 14 generates updated heuristic rules or combines efficiently multiple strategies by utilizing the generative model GM. Thus, the updating section 14 can automatically adapt to problems with new or dynamic constraints such as joint task allocation and path planning problem.

### Step S151

Next, in the step S151, the vehicle controlling section 15 outputs, to the vehicles 50-1 to 50-3, the re-optimized solution plan SL obtained in the step S145 in order to control the vehicles 50-1 to 50-3.

### Step S152

In the step S152, the vehicle controlling section 15 determines whether it is end of the day. If it is the end of the day (Yes in the step S152), the process ends. Otherwise (No in the step S152), the process goes back to step S141.

### Effect of Controlling System 100A

As has been described, the controlling system 100A employs a configuration such that:
the input data including the problem setting PS of the target online optimization problem is obtained;
the metaheuristic solver SV is automatically generated with reference to the problem setting PS;
the target problem including one or more tasks TS is solved by using the metaheuristic solver SV, and a solution SL to the target problem including the one or more tasks TS is provided;
the metaheuristic solver SV is automatically updated with reference to a new task TS, and a solution SL to the target problem including the new task TS is provided; and
the one or more vehicles 50-1 to 50-3 are controlled in accordance with the solution SL derived by the solving section 13 or the updating section 14.
   According to the above configuration, the metaheuristic solver SV is automatically generated by the generating section 12 and updated by the updating section 14. Then the one or more vehicles 50-1 to 50-3 are controlled in accordance with the solution SL derived by the solving section 13 or the updating section 14. Therefore, according to the above configuration, it is possible to efficiently control one or more vehicles by using a technique of online optimization with improved flexibility and throughput. More specifically, according to the above configuration, it is possible to improve the throughput by dynamically adapting the solvers SV for online optimization problems with agentization. In other words, the information processing apparatus may serve as an AI agent to carry out automated dynamic planning of joint task allocation and path planning problem.

Furthermore, the solving section 12 and the updating section 13 may utilize the generative model GM (large language model LLM) to generate and update the metaheuristic solver SV. Thus the generation and update of the metaheuristic solver SV can be appropriately carried out.

Furthermore, the solving section 13 and the updating section 14 in cooperation with the collision detecting section 16 and the cost modifying section 17 may provide collision-free paths as the (updated) solution plan SL. Thus, according to the above configuration, it is possible to enhance the safety of the vehicle controlling.

### Application Examples

A target to which the information processing apparatus 1A in accordance with the present example embodiment can be applied is not particularly limited, and the information processing apparatus 1A in accordance with the present example embodiment can be applied to various fields which require online optimization. Such fields may include warehousing or logistics, using AGVs or other autonomous robots to process operations to service customers. Such fields may also include drone delivery services using a plurality of autonomous drones to process operations to service customers. The above services deal with highly dynamic optimization problems, and the information processing apparatus 1A in accordance with the present example embodiment can generate adapted metaheuristics and handle dynamic optimization processing appropriately.

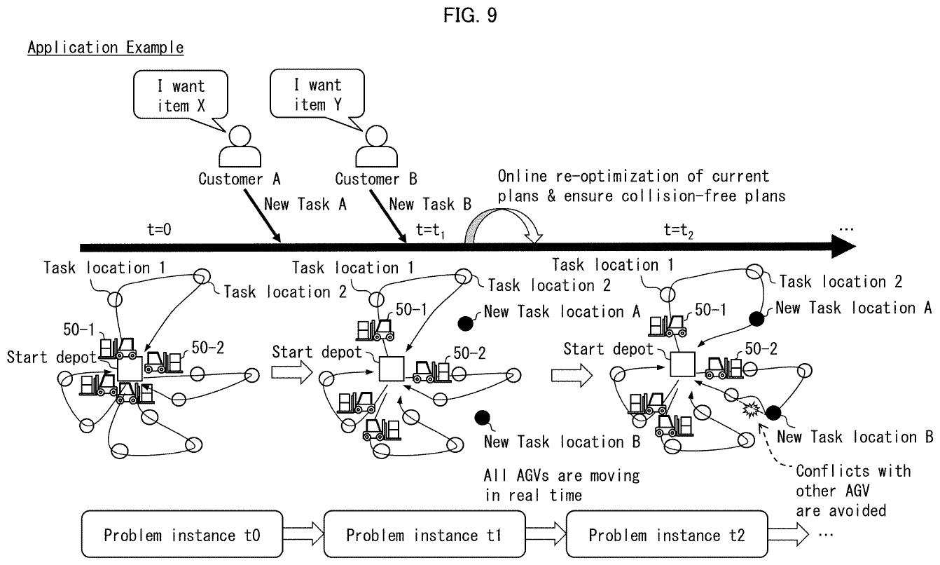

In the following, an example application of the information processing apparatus 1A is described with reference to FIG. 9. FIG. 9 is a schematic diagram illustrating the time line of the example application. As illustrated in FIG. 9, at time t=0, a plurality of vehicles 50 are located at the start depot, and just start picking up and/or delivering items. At t=0, the problem settings PS and initial tasks may consist of a problem instance t0 as illustrated in FIG. 9. Here, the problem settings PS may include the above-mentioned rules or conditions. In accordance with the problem instance t0, the information processing apparatus 1A derives a solution plan PL. Here, the solution plan PL indicates that the vehicle 50-1 should deliver an item to the task location 1, deliver another item to the task location 2, and then go back to the start depot (goal depot).

As time proceeds, the customer A and B respectively send new requests. The request from the customer A may be inputted to the terminal apparatus 70-1, while the request from the customer B may be inputted to the terminal apparatus 70-2. Here, the request from the customer A may be referred to as a new task A, while the request from the customer B may be referred to as a new task B. The new tasks A and B are received by the information processing apparatus 1A and included in the problem instance t1. Then, at time t=t1, the updating section 14 re-optimizes the solution plan PL by taking into account the new tasks. Then, the re-optimized solution plan PL is transmitted to the vehicles 50. As illustrated at time t=t2, the re-optimized solution plan PL indicates that the vehicle 50-1 should deliver yet another item to the new task location A, and the vehicle 50-2 should deliver an item to the new task location B. Note also that due to the solving section 13 and the updating section 14 in cooperation with the collision detecting section 16 and the cost modifying section 17, the re-optimized solution plan PL includes collision-free paths. Thus, as illustrated in FIG. 9, a collision of vehicle 50-2 and other vehicle is avoided.

As explained in the above example embodiments and the example application, the information processing apparatus 1A can realize fully automated processing of operations with changing conditions, and increase the throughput (number of serviced requests) and the service level.

### Software Implementation Example

Some or all of the functions of the information processing apparatuses 1 and 1A (hereinafter also referred to as “each apparatus”) may be implemented by hardware such as an integrated circuit (IC chip), or may be implemented by software.

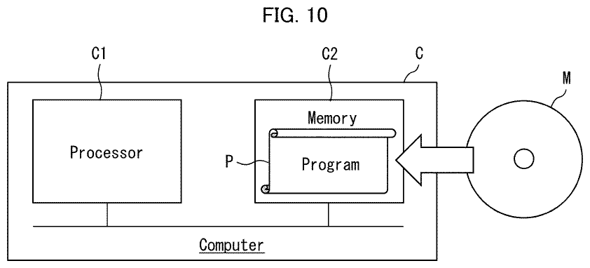

In the latter case, the each apparatus is realized by, for example, a computer that executes the instructions of a program that is software realizing the functions. FIG. 10 illustrates an example of such a computer (hereinafter, referred to as “computer C”). FIG. 10 is a block diagram illustrating a hardware configuration of the computer C which functions as the each apparatus.

The computer C includes at least one processor C1 and at least one memory C2. In the memory C2, a program P for causing the computer C to operate as the each apparatus is recorded. In the computer C, the processor C1 retrieves the program P from the memory C2 and executes the program P, so that the functions of the each apparatus are implemented.

The processor C1 can be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. The memory C2 can be, for example, a flash memory, a hard disk drive (HDD), a solid state drive (SSD), or a combination of these.

Note that the computer C may further include a random access memory (RAM) in which the program P is loaded in a case where the program P is executed and in which various kinds of data are temporarily stored. The computer C may further include a communication interface via which the computer C transmits and receives data to and from another apparatus. The computer C may further include an input/output interface via which the computer C is connected to an input/output apparatus such as a keyboard, a mouse, a display, and a printer.

The program P can be recorded in a non-transitory tangible recording medium M which is readable by the computer C. Such a recording medium M can be, for example, a tape, a disk, a card, a semiconductor memory, a programmable logic circuit, or the like. The computer C can obtain the program P via the recording medium M. The program P can be transmitted via a transmission medium. The transmission medium can be, for example, a communications network, a broadcast wave, or the like. The computer C can obtain the program P also via such a transmission medium.

### Additional Remark

The present disclosure includes techniques described in supplementary notes below. Note, however, that the present invention is not limited to the techniques described in the supplementary notes below, but may be altered in various ways by a skilled person within the scope of the claims.

### Supplementary Note A1

An information processing apparatus for solving one or more online optimization problems, comprising at least one processor and a memory which is configured to store instructions,
the at least one processor executing:
   an obtaining process of obtaining a problem setting;
   a generating process of generating a metaheuristic solver with reference to the problem setting;
   a solving process of solving a problem including one or more tasks using the metaheuristic solver so as to provide a solution to the problem including the one or more tasks; and
   an updating process of updating the metaheuristic solver with reference to a new task so as to provide a solution to the problem including the new task.

### Supplementary Note A2

The information processing apparatus as set forth in Supplementary note A1, wherein
in the solving process, the at least one processor executing:
   a first task-obtaining process of obtaining one or more initials task; and
   a first task-solving process of solving a problem including the one or more initial tasks using the metaheuristic solver so as to provide a solution to the problem including the one or more initial task.

### Supplementary Note A3

The information processing apparatus as set forth in Supplementary note A2, wherein
in the updating process, the at least one processor executing:
   a second task-obtaining process of obtaining a new task;
   a solver-updating process of updating the metaheuristic solver with reference to the new task; and
   a second task-solving process of solving the problem including the new task using the updated metaheuristic solver so as to provide a solution to the problem including the new task.

### Supplementary Note A4

The information processing apparatus as set forth in Supplementary note A3, wherein
in the updating process, the at least one processor further executing:
   a decision making process of making a decision whether to solve the new task or to wait for another new task.

### Supplementary Note A5

The information processing apparatus as set forth in Supplementary note A4, wherein
in the decision making process, the at least one processor further executing:
   a deciding process of deciding how to solve the new task.

### Supplementary Note A6

The information processing apparatus as set forth in Supplementary note A4, wherein
in the generating process, the at least one processor executing:
   a prompt generating process of generating a prompt to be inputted in a generative model, the prompt including the problem setting; and
   a solver obtaining process of obtaining the metaheuristic solver generated by the generative model with re

[symbol]

### Supplementary Note A7

The information processing apparatus as set forth in Supplementary note A6, wherein
in the decision making process, the at least one processor utilizes the generative model to make the decision.

### Supplementary Note A8

The information processing apparatus as set forth in Supplementary note A4, wherein
the problem setting includes one or more constraint conditions, and one or more cost functions.

### Supplementary Note A9

A controlling system for solving one or more online vehicle routing problems and for controlling a plurality of vehicles, the controlling system comprising at least one processor and a memory which is configured to store instructions,
the at least one processor executing:
   an obtaining process of obtaining a problem setting;
   a generating process of generating a metaheuristic solver with reference to the problem setting;
   a solving process of solving a problem including one or more tasks using the metaheuristic solver so as to provide a solution to the problem including the one or more tasks;
   an updating process of updating the metaheuristic solver with reference to a new task so as to provide a solution to the problem including the new task; and
   a controlling process of controlling the vehicles by providing, to the vehicles, the solution provided by the solving process or the updating process.

### Supplementary Note A10

An information processing method for solving one or more online optimization problems, executed by least one processor, comprising:
obtaining a problem setting;
generating a metaheuristic solver with reference to the problem setting;
solving a problem including one or more tasks using the metaheuristic solver so as to provide a solution to the problem including the one or more tasks; and
updating the metaheuristic solver with reference to a new task so as to provide a solution to the problem including the new task.

### Supplementary Note A11

A non-transitory recording medium in which a program for causing a computer to function as the information processing apparatus recited in Supplementary note A1 is stored, the program causing the computer to execute the obtaining process, the generating process, the solving process, and the updating process.

### Supplementary Note B1

A program for causing a computer to carry out:
an obtaining process of obtaining a problem setting;
a generating process of generating a metaheuristic solver with reference to the problem setting;
a solving process of solving a problem including one or more tasks using the metaheuristic solver so as to provide a solution to the problem including the one or more tasks; and
an updating process of updating the metaheuristic solver with reference to a new task so as to provide a solution to the problem including the new task.

### Supplementary Note C1

An information processing apparatus for solving one or more online optimization problems, comprising
an obtaining section to obtain a problem setting;
a generating section to generate a metaheuristic solver with reference to the problem setting;
a solving section to solve a problem including one or more tasks using the metaheuristic solver so as to provide a solution to the problem including the one or more tasks; and
an updating section to update the metaheuristic solver with reference to a new task so as to provide a solution to the problem including the new task.

### REFERENCE SIGNS LIST

100, 100A Controlling system
1, 1A Information processing apparatus
11 Obtaining section (obtaining means)
12 Generating section (Generating means)
13 Solving section (solving means)
14 Updating section (updating means)
15 Controlling section (controlling means)
16 Collision detecting section
17 Cost modifying section

1. An information processing apparatus for solving one or more online optimization problems, comprising at least one processor and a memory which is configured to store instructions,
the at least one processor executing:
an obtaining process of obtaining a problem setting;
a generating process of generating a metaheuristic solver with reference to the problem setting;
a solving process of solving a problem including one or more tasks using the metaheuristic solver so as to provide a solution to the problem including the one or more tasks; and
an updating process of updating the metaheuristic solver with reference to a new task so as to provide a solution to the problem including the new task.

2. The information processing apparatus as set forth in claim 1, wherein
in the solving process, the at least one processor executing:
a first task-obtaining process of obtaining one or more initial tasks; and
a first task-solving process of solving a problem including the one or more initial tasks using the metaheuristic solver so as to provide a solution to the problem including the one or more initial tasks.

3. The information processing apparatus as set forth in claim 2, wherein
in the updating process, the at least one processor executing:
a second task-obtaining process of obtaining a new task;
a solver-updating process of updating the metaheuristic solver with reference to the new task; and
a second task-solving process of solving the problem including the new task using the updated metaheuristic solver so as to provide a solution to the problem including the new task.

4. The information processing apparatus as set forth in claim 3, wherein
in the updating process, the at least one processor further executing:
a decision making process of making a decision whether to solve the new task or to wait for another new task.

5. The information processing apparatus as set forth in claim 4, wherein
in the decision making process, the at least one processor further executing:
a deciding process of deciding how to solve the new task.

6. The information processing apparatus as set forth in claim 4, wherein
in the generating process, the at least one processor executing:
a prompt generating process of generating a prompt to be inputted in a generative model, the prompt including the problem setting; and
a solver-obtaining process of obtaining the metaheuristic solver generated by the generative model with reference to the prompt.

7. The information processing apparatus as set forth in claim 6, wherein
in the decision making process, the at least one processor utilizes the generative model to make the decision.

8. The information processing apparatus as set forth in claim 4, wherein
the problem setting includes one or more constraint conditions, and one or more cost functions.

9. A controlling system for solving one or more online vehicle routing problems and for controlling a plurality of vehicles, the controlling system comprising at least one processor and a memory which is configured to store instructions,
the at least one processor executing:
an obtaining process of obtaining a problem setting;
a generating process of generating a metaheuristic solver with reference to the problem setting;
a solving process of solving a problem including one or more tasks using the metaheuristic solver so as to provide a solution to the problem including the one or more tasks;
an updating process of updating the metaheuristic solver with reference to a new task so as to provide a solution to the problem including the new task; and
a controlling process of controlling the vehicles by providing, to the vehicles, the solution provided by the solving process or the updating process.

10. An information processing method for solving one or more online optimization problems, executed by least one processor, comprising:
obtaining a problem setting;
generating a metaheuristic solver with reference to the problem setting;
solving a problem including one or more tasks using the metaheuristic solver so as to provide a solution to the problem including the one or more tasks; and
updating the metaheuristic solver with reference to a new task so as to provide a solution to the problem including the new task.

11. A non-transitory recording medium in which a program for causing a computer to function as the information processing apparatus recited in claim 1 is stored, the program causing the computer to execute the obtaining process, the generating process, the solving process, and the updating process.
